(19) United States
(12) Patent Application Publication
(10) Pub. No.: US 2010/0293555 A1
(43) Pub. Date: Nov. 18, 2010

(54) METHOD AND APPARATUS OF MESSAGE ROUTING

(75) Inventor: Ari M. VEPSALAINEN, Espoo (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/465,976

(22) Filed: May 14, 2009

(51) Int. Cl. G06F 13/00

(52) U.S. Cl. 719/313

(57) ABSTRACT

An approach is provided for the improvement of a messaging bus. A message from a sender application platform associated with a realm is encoded. It is determined that the message is to be transported, using a messaging bus, over one or more other realms to a receiver application platform. Each of the application platforms is configured to communicate over the messaging bus and to provide one or more services to one or more mobile devices.

### BACKGROUND

Service providers and device manufacturers are continually challenged to deliver value and convenience to consumers by, for example, providing compelling network services, applications, and content, as well as user-friendly devices. Important differentiators in this industry are application and network services. In particular, these applications and services can be optimized to communicate with additional applications and services in a way that can scale geographically.

### SOME EXAMPLE EMBODIMENTS

According to one embodiment, a method comprises encoding a message from a sender application platform associated with a realm; and determining that the message is to be transported, using a messaging bus, over one or more other realms to a receiver application platform, wherein each of the application platforms is configured to communicate over the messaging bus and to provide one or more services to one or more mobile devices.

According to another embodiment, a computer-readable medium carries one or more sequences of one or more instructions which, when executed by one or more processors, cause an apparatus to perform at least the following: encoding a message from a sender application platform associated with a realm; and determining that the message is to be transported, using a messaging bus, over one or more other realms to a receiver application platform, wherein each of the application platforms is configured to communicate over the messaging bus and to provide one or more services to one or more mobile devices.

According to another embodiment, an apparatus comprises at least one processor, and at least one memory including computer program code. The at least one memory and the computer program code configured to, with the at least one processor, cause the apparatus to perform at least the following: encode a message from a sender application platform associated with a realm, and determine that the message is to be transported, using a messaging bus, over one or more other realms to a receiver application platform, wherein each of the application platforms is configured to communicate over the messaging bus and to provide one or more services to one or more mobile devices.

According to another embodiment, an apparatus comprises means for encoding a message from a sender application platform associated with a realm; and means for determining that the message is to be transported, using a messaging bus, over one or more other realms to a receiver application platform, wherein each of the application platforms is configured to communicate over the messaging bus and to provide one or more services to one or more mobile devices.

According to another embodiment, a method comprises receiving an encoded message from a sender application platform associated with a source realm; retrieving a code corresponding to the encoded message; decoding the encoded message using the retrieved code; and initiating sending of the decoded message to a receiver application platform associated with a destination realm, wherein each of the application platforms is configured to provide one or more services to one or more mobile devices.

According to another embodiment, a computer-readable medium carries one or more sequences of one or more instructions which, when executed by one or more processors, cause an apparatus to perform at least the following: receiving an encoded message from a sender application platform associated with a source realm; retrieving a code corresponding to the encoded message; decoding the encoded message using the retrieved code; and initiating sending of the decoded message to a receiver application platform associated with a destination realm, wherein each of the application platforms is configured to provide one or more services to one or more mobile devices.

According to another embodiment, an apparatus comprises at least one processor, and at least one memory including computer program code. The at least one memory and the computer program code configured to, with the at least one processor, cause the apparatus to perform at least the following: receive an encoded message from a sender application platform associated with a source realm; retrieve a code corresponding to the encoded message; decode the encoded message using the retrieved code; and initiate sending of the decoded message to a receiver application platform associated with a destination realm, wherein each of the application platforms is configured to provide one or more services to one or more mobile devices.

According to yet another embodiment, an apparatus comprises means for receiving an encoded message from a sender application platform associated with a source realm; means for retrieving a code corresponding to the encoded message; decoding the encoded message using the retrieved code; and means for initiating sending of the decoded message to a receiver application platform associated with a destination realm, wherein each of the application platforms is configured to provide one or more services to one or more mobile devices.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A and 1B are diagrams of a system capable of supporting a scalable messaging bus, according to various embodiments;

FIG. 2 is a system diagram of messaging buses within user equipment and services platform, according to various embodiments;

FIG. 3 is a sequence diagram for routing and compressing messages, according to one embodiment;

FIG. 4A and 4B are flowcharts of processes for sending and receiving a message, according to various embodiments;

FIG. 5 is a sequence diagram for routing messages, according to one embodiment;

FIG. 6 is a flowchart of a process for routing messages, according to one embodiment;

FIG. 7 is a sequence diagram for notifying subscriber endpoints of new information, according to one embodiment;

FIG. 8 is a flowchart of a process of notifying a subscriber endpoint of new information, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF PREFERRED EMBODIMENTS

A method and apparatus for improving messaging services using a messaging bus. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to mobile devices and application services, it is contemplated that the approach described herein may be used with other devices and applications.

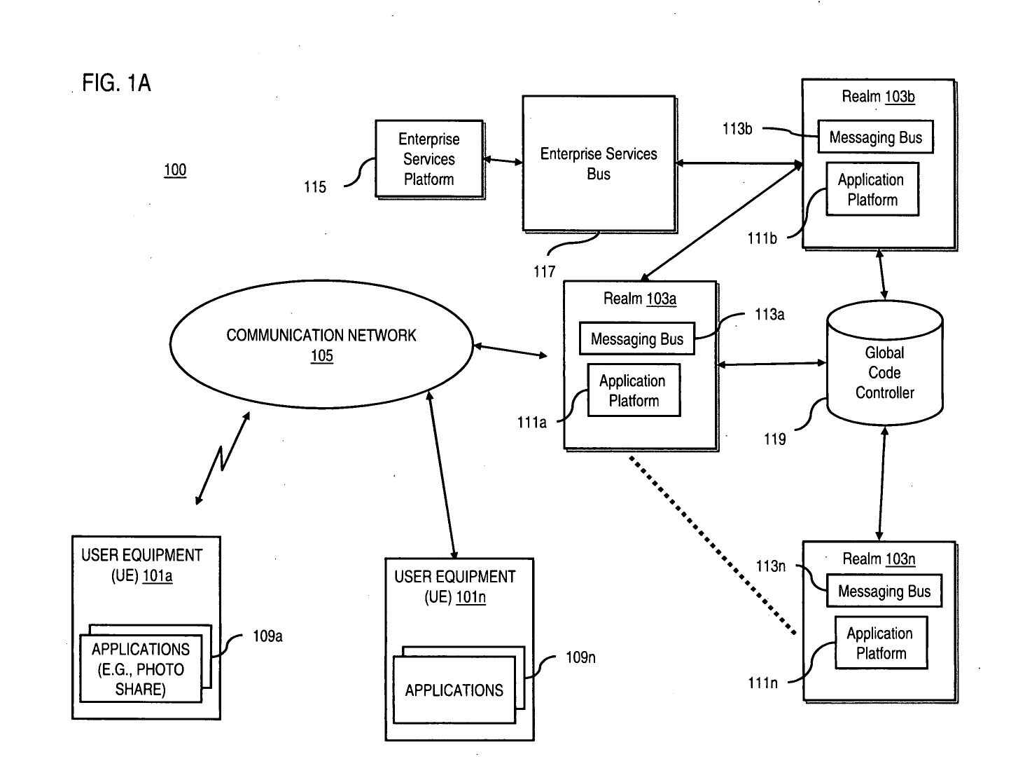

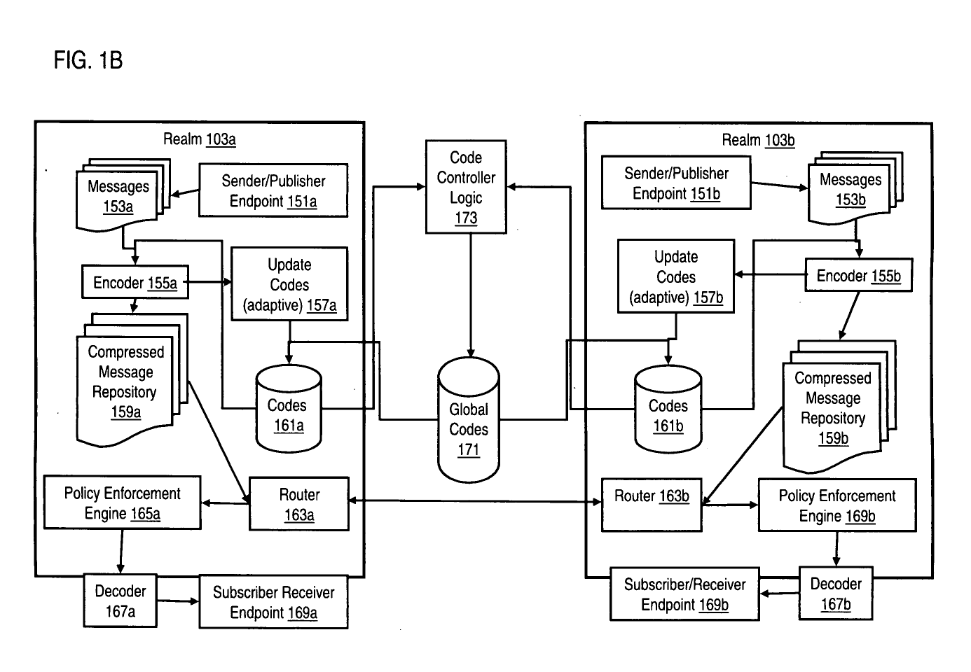

FIGS. 1A and 1B are diagrams of a system capable of supporting a scalable messaging bus, according to various embodiments. For the purposes of illustration, system 100 provides for the efficiency of communication services on a user equipment. As shown in FIG. 1A, system 100 comprises one or more user equipment (UEs), e.g., UEs 101a-101n , having connectivity to application platforms 111a-111n within realms 103a-103n , respectively, via a communication network 105. As used herein, a “realm” can be a geographically separated service site. The application platforms 111a-111n provide a number of services, which can include, for instance, mobile maps, music downloads, mobile games, photo sharing, file storage, synchronization of files with desktop computers, etc. Other applications or services can provide access to calendar and files wherever a user is, whether by mobile device, Internet cafe, or a home personal computer (PC). These applications and services can be optimized to communicate with additional applications and services in a way that can scale geographically through the use of a messaging bus.

System 100, according to certain embodiments, utilize a messaging bus to provide efficient communications and services. A messaging bus is a logical component that can connect applications and services running on platforms 111a-111n . The messaging bus transports the messages between applications. The messaging bus uses a messaging scheme that is compatible with each of the applications. The messaging bus can also have a set of common message commands. The messaging bus can also have a common infrastructure for sending bus messages to receivers. When using a messaging bus, a sender application sends a message to the bus, the messaging bus then transports the message to applications listening to the bus for the message.

Additionally, in certain embodiments, the messaging bus can be associated with a publisher and subscriber messaging model where when a message is published, the message is sent to subscriber nodes. The publisher and subscriber model can include a list-based implementation, a broadcast-based implementation, or a content-based implementation. In a list-based subscription model, a list is maintained of publishing topics/subjects and subscribers/observers and notifying the subscribers/observers when an event occurs. In a broadcast-based model, a message bus broadcasts the message to all of the nodes listening to the bus and the listening node (subscriber) filters unwanted messages. In the content-based model, when the bus receives a message, it matches the message against a set of subscribers and forwards the message to the appropriate subscribers. The producers and subscribers can be various applications and services. For example, a music news application in a realm in Arizona can subscribe to a producer news service in a realm in New York.

The application platform 111a can be used by a UE 101a application 109a to service a user's music, people, places, photo sharing, and other application services needs. In one embodiment, the application platform 111a can be used to access application platforms 111b-111n in different realms 103b-103n ; these realms 103b-103n can be geographically dispersed. The application platforms 111b-111n in different realms 103b-103n can carry additional services, such as networks services, games, farming services, and video services. Further, services in realm 103a can access the services in realm 103b and realm n 103n via a messaging bus 113b . Additionally, a service in realm 103a can access an external service on an enterprise services platform 115 via an enterprise services bus 117. The realms 103 can message each other using a global code controller 119.

The UEs 101a-101n are any type of mobile terminal, fixed terminal, or portable terminal including mobile handsets, mobile phones, mobile communication devices, stations, units, devices, multimedia tablets, digital book readers, game devices, audio/video players, digital cameras/camcorders, positioning device, televisions, radio broadcasting receivers, Internet nodes, communicators, desktop computers, laptop computers, Personal Digital Assistants (PDAs), or any combination thereof. Under this scenario, the UE 101a employs a radio link to access network 105, while connectivity of UE 101n to the network 105 can be provided over a wired link. It is also contemplated that the UEs 101a-101n can support any type of interface to the user (such as “wearable” circuitry, etc.).

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like. In addition, the wireless network may be, for example, a short range network, such a Bluetooth® network, ultra wide band (UWB) network, radio frequency identification (RFID) network or infrared network (IrDA).

By way of example, the UEs 101a-101n can communicate with an application platform 111a over the communication network 105 using standard protocols. The UEs 101a-101n and the platform 111a are network nodes with respect to the communication network 105. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are effected, for example, by exchanging discrete packets of data. Each packet comprises, for example, (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol indicates, for example, a type for the next protocol contained in its payload. The higher layer protocol is said to be encapsulated in the lower layer protocol. The headers included in a packet traversing multiple heterogeneous networks, such as the Internet, include, for example, a physical (layer 1) header, a data-link (layer 2) header, an internetwork (layer 3) header and a transport (layer 4) header, and various application headers (layer 5, layer 6 and layer 7) as defined by the OSI Reference Model.

FIG. 1B diagrams a messaging system between two realms, according to one embodiment. A sender or publisher endpoint 151a in realm 103a can send a message 153a to a subscriber or receiver endpoint 169a -169b in either realm 103a or realm 103b . A message, for instance, includes a payload that comprises a header and a body. The message can also have a message identification and a correlation identification. The correlation identification uniquely identifies a node across multiple systems or realms. The message identification uniquely identifies the message across multiple systems or realms. Messages can be represented by message type, such as a Java messaging service (JMS), a text message, a bytes message, an object message, a stream message, or a map message.

In one embodiment, the messages can be sent using a point-to-point model. In a point-to-point model, a one consumer may receive the message that has been sent through a message oriented middleware. Such a system is generally restricted to two endpoints.

According to certain embodiments, messages can be sent from senders (producers) through a message oriented middleware to a receiver (consumer) that consumes the message. Senders and receivers can be applications or services with access to a message bus. Messages 153 can be stored in message oriented middleware to increase reliability that it will be received. The message storage system can routinely clean the persistent storage of any garbage that has not been delivered. Many messages 153, such as messages 153 between a specific and a generic news service, are bound within a realm 103. However, some messages 153, such as messages 153 between social networks are not bounded by realms 103. Under this scenario, realm 103 is a geographically separated site. One aspect of realm 103 is to produce efficient local messaging within the realm 103.

Messages can be encoded to increase speed, efficiency, security, or save space by reducing size of the message. The message 153a can be encoded by an encoder 155a . The encoder 155a can encode the message 153a from a complete message 153a into blocks of the message 153a using various algorithms, such as an adaptive Huffman coding, arithmetic coding, cryptographic coding, and other information entropy coding.

According to one embodiment, compression coding algorithms can be static or adaptive. In a static algorithm, data is analyzed and then a model is constructed. In this example, data can be compressed using a single model. An adaptive model dynamically updates the model as data is compressed. Both the encoder 155a -155b and decoder 167a-167b begin with a trivial code for encoding, yielding poor compression of initial data. However, the encoder 155 and decoder 167 learn more about the data to optimize the compression, thereby improving coding performance. As the encoder 155 changes codes used to encode data, it updates 157a-157b a local code database 161a -161b with new codec codes. New codes stored in the code database 161 are used to update a global code database 171 using global code controller logic 173. Thus, each realm 103 can be optimized for its internal efficiency while sharing its codes with other realms 103 for compatibility and scaling.

Once a message 153 is encoded, the message 153 can be stored in a compressed message repository 159a -159b . Messages 153 and message parts can be routed to other realms 103a-103b or locally from the repository 159 to a subscriber or receiver endpoint 169a -169b . Common message blocks can be used to increase service efficiency through the compressed message repository 159. Thus, a message block stored in the repository 159 may be routed to and accessed by a subscriber or receiver endpoint 169 even though the endpoint 169 is not the intended receiver of the message the block was encoded for. Common messages can remain in the repository 159 until cleaned using common caching techniques.

According to one embodiment, a policy enforcement engine 165a -165b can be used to regulate which message blocks a subscriber or receiver endpoint 169 can access. For instance a receiver may have access to three out of five blocks of a message sent by one sender to a different receiver.

Routers 163a-163b can be used to route messages to endpoints and across different realms 103. Router 163 need not send a complete message 153 from a sender realm 103a to receiver realm 103b if common message blocks are found in the compressed message repository 159b of the receiver realm 103b , thereby improving latency of a service transaction as well as costs of sending data over a network.

In one embodiment, when a message 153 is routed from realm 103a to another realm 103b , a global code controller logic 173 is used to share coding data. The local code database 161 of the realm 103 is replicated or copied to the global code controller 173. The global code controller 173 can monitor and analyze message streams and update local codes 161 in each realm 103 based on decoding needs or prediction. For decoding, a global code controller 173 will replicate a local code database 161 from a global code database 171 if messages 153 in the realm 103 use codes that have not yet been replicated to the realm 103. For predictive mode, a global code controller 173 analyzes the amount of different type of messages 153 in each realm 103 and if there is a trend of increasing messages 153 being sent from one realm 103, that realm's code database 161 will be copied over to other realms where messages 153 may be received. A trend can occur, for example, if an important event occurs at one realm 103 that applications in the realm 103 want to communicate to applications in other realms 103.

Once a message 153 and its code are received at a decoder 167, the message 153 can be decoded. The decoder 167 uses the locally available codes for the message 153 to decode the message blocks. If the proper code is not available, a need request can be sent to the global code controller to gather the proper code. The decoding can be done before it is received at a receiver endpoint 169 or at a receiver endpoint 169.

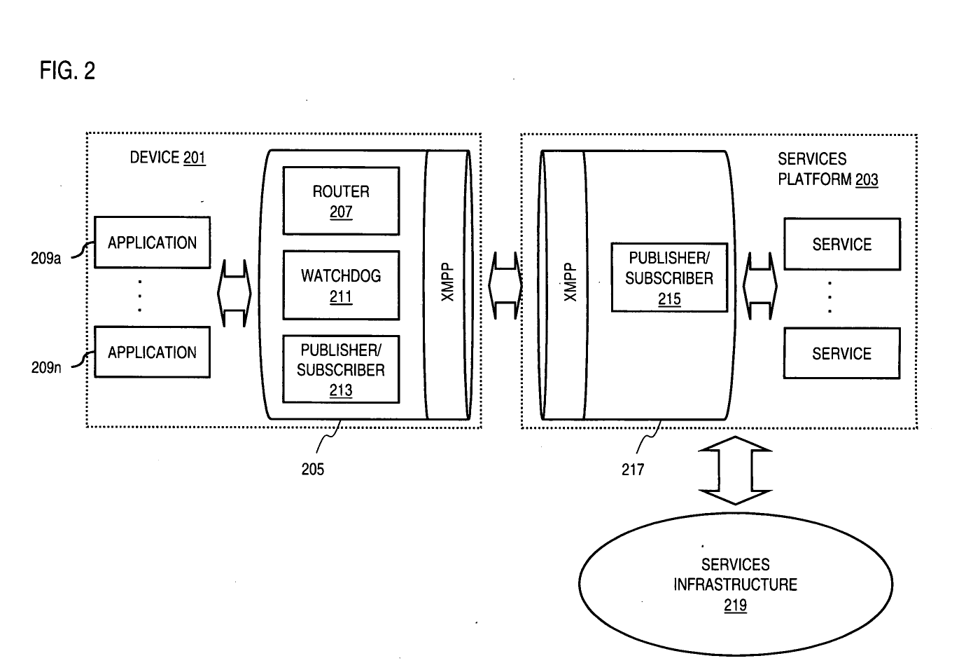

FIG. 2 is a system diagram of messaging buses within user equipment and services platform, according to various embodiments. A device 201, such as UE 101, can communicate with a services platform 203 via a client messaging bus 205. In this example, the device 201 runs applications that use the services provided by the services platform 203. The device 201 can send and receive messages with a services platform 203 through a protocol, such as Extensible Messaging and Presence Protocol (XMPP). A client device messaging bus 205 can receive XMPP messages and route them by router 207 to the appropriate application 209a -209n . If the application 209 is not running, a watchdog module 211 launches the application 209, passing the message in the launch parameters. In certain embodiments, either the device 201 or the services platform 203 can be the publisher or subscriber 213 and 215. Services can communicate to a server side messaging bus 217 using a Representational State Transfer (REST) Application Programming Interface (API) or messaging bus agents. The services platform 203 can also communicate with a services infrastructure 219 using a REST API or messaging bus agents. The services infrastructure 219 can include enterprise services bus services using a different bus structure.

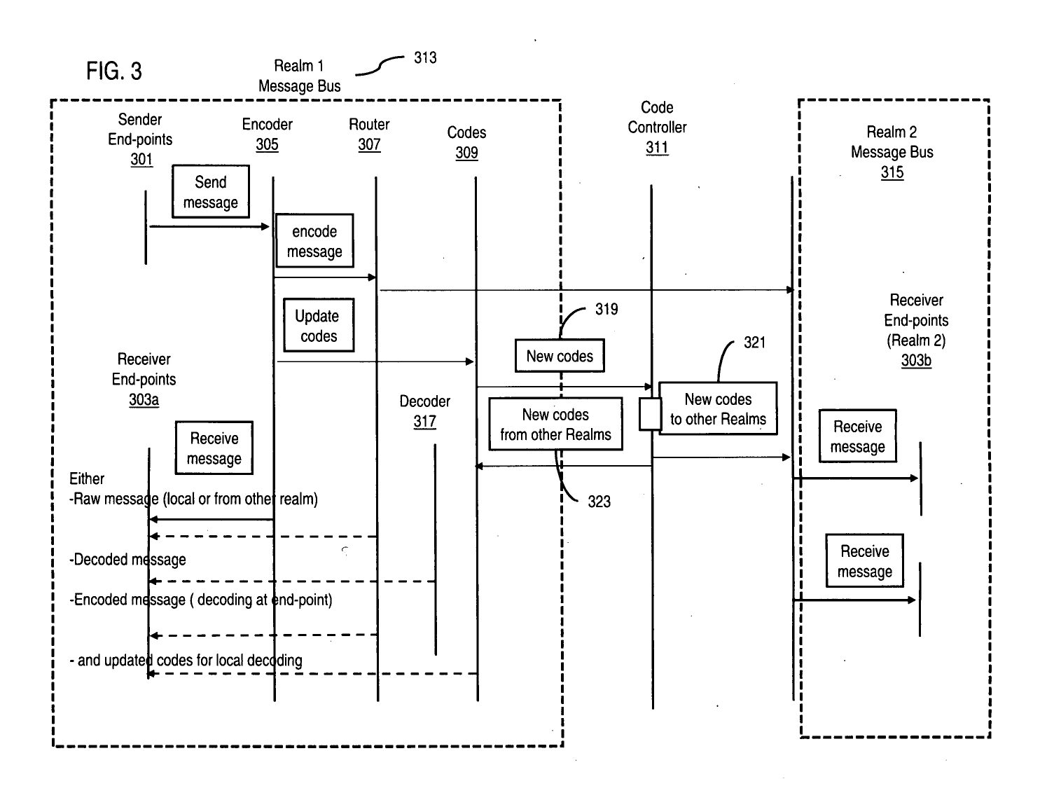

FIG. 3 is a sequence diagram for routing and compressing messages, according to one embodiment. Under this scenario, a sender endpoint 301 in realm 1 313 sends a message to a receiver endpoint 303a-303b . The message is then encoded by the encoder 305 and routed to the receiver endpoint 303 by a router 307. Once the encoder 305 encodes the message, the encoder 305 updates the codes in a local codes database 309. New codes 319 that have not been previously used are sent to a global code controller 311. If the message is sent to realm 2 315, the global code controller 311 determines if realm 2 315 has access to the code associated with the sent message and if the code is not available, the global code controller 311 updates the local code database in realm 2 315 with new codes 321. If a message is being sent from realm 2 315 to realm 1 313, the global code controller 311 can update the realm 1 313 local code database 309 with new codes 323. Once a message is routed to its destination, a decoder 317 can be used to decode the message for the receiver endpoint 303. The message can be decoded at the endpoint or by the messaging bus.

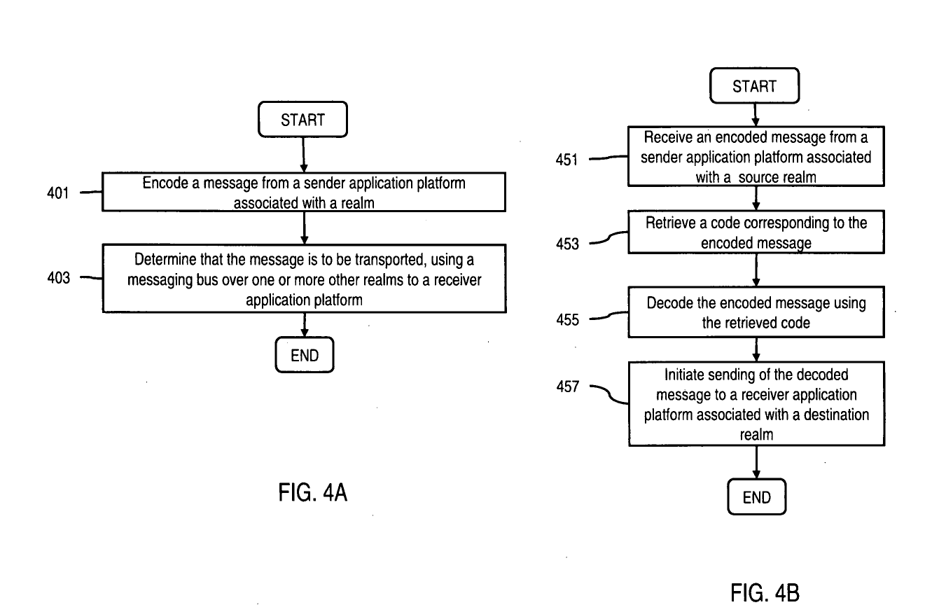

FIG. 4A is a flowchart of a process for sending a message, according to one embodiment. The flowchart shows the processes of a bus, like a message bus, for application platforms that are configured to communicate over the messaging bus and to provide one or more services to one or more mobile devices. At step 401, a message from the sender application platform endpoint 301 is encoded. At step 403, it is determined that the message is to be transported, using a messaging bus, over one or more realms to a receiver application platform endpoint 303. The message is then transported to the destination realm.

FIG. 4B is a flowchart of a process for receiving a message, according to one embodiment. At step 451, an encoded message is received at a destination realm from a sender application platform endpoint 301 associated with a source realm. The source realm is run on a messaging bus compatible with the destination realm. At step 453, a code corresponding to the encoded message is then retrieved. If the local code database does not contain the proper code, a global code controller 311 can send the local code database of the destination realm the code. At step 455, the encoded message is decoded using the retrieved code. At step 457, the decoded message is sent to a receiver application platform associated with the destination realm. Message encoding and decoding can be optimized specifically to a single realm, while codes can be shared between realms for compatibility and scaling purposes.

With the above approach, a service provider, for instance, can maximize the experience of a user in an efficient way. Moreover, a one application can communicate with another application using a messaging bus. The messaging bus is optimized by the above approach to decrease overhead by defining, in one embodiment, geographic realms. This can increase the capacity of the messaging bus as well as reduce latency. Capabilities of such a messaging bus could scale to numerous event messages/s to a target involving millions of users. Also, storage needed to persist messages is improved to increase scalability because storage for the bus system is geographically split among different realms.

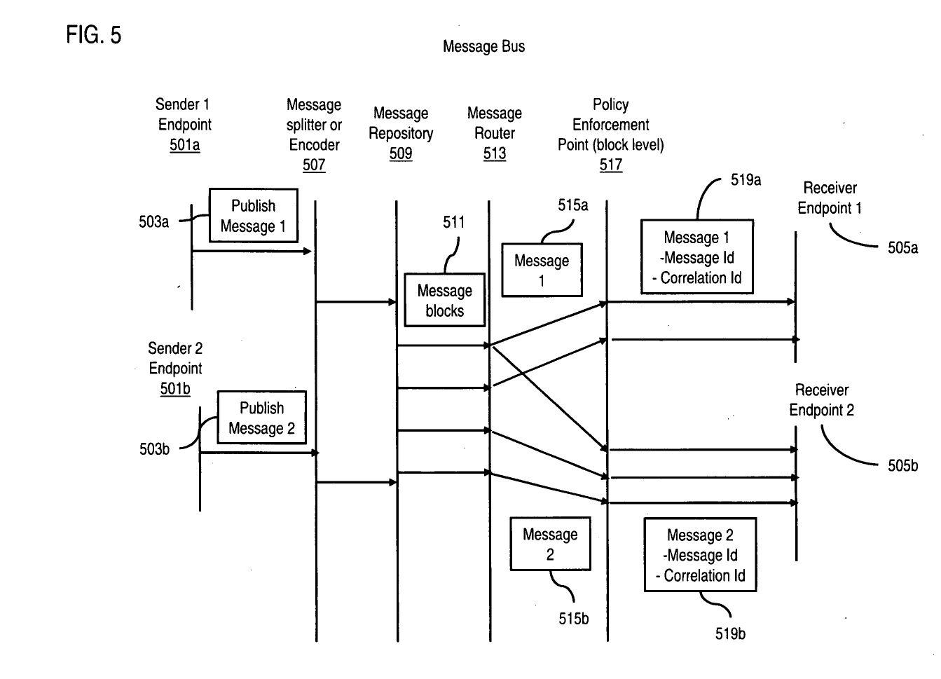

FIG. 5 is a sequence diagram for routing messages, according to one embodiment. Sender endpoints 501a-501b publish messages 503a , 503b intended to be received at receiver endpoints 505a , 505b . Examples of sender endpoints 501 could be a user on a mobile device wishing to share a news article or photos with a group of friends, who can be receiver endpoints 505. Once the messages are published to the message bus, a message splitter or encoder 507 is used to partition the messages into message blocks 511. The message blocks 511 are stored at a message repository 509. Some of the message blocks 511 can be common message blocks and shared between senders and receivers. Blocked messages can also have user-level access control rules to help determine which blocks should be sent to which users. The blocked messages 515a , 515b can then be routed via a message router 513 to a policy enforcement engine 517 that can decide which blocks a receiver endpoint can receive. An endpoint can be identified using a correlation identification (correlation ID) that uniquely identifies the endpoint across multiple systems or realms. A message 515 can have a message identification (message ID) that uniquely identifies the message 515. The policy enforcement engine 517 can use these unique identifiers to determine if the receiver endpoint should receive a message block. As shown in FIG. 5, certain message blocks 511 can be common to multiple messages and routed to multiple receiver endpoints 505 to assemble complete messages 519a , 519b.

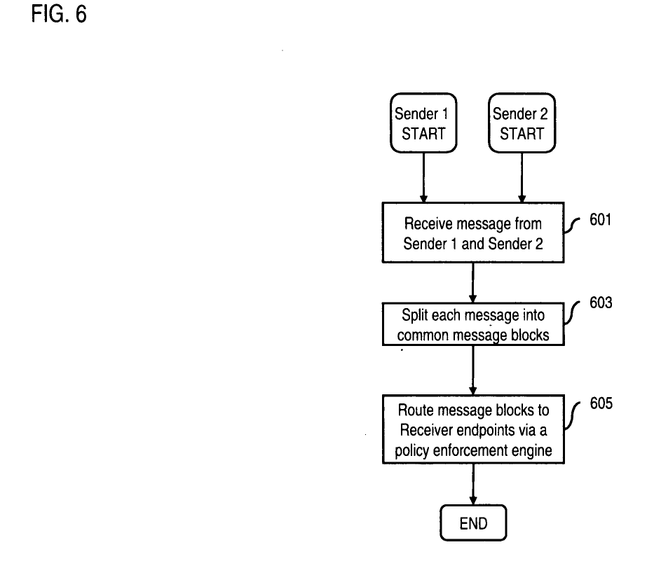

FIG. 6 is a flowchart of a process for routing messages, according to one embodiment. At step 601, two messages are received from multiple sender endpoints 501. At step 603, each of the messages 503 are partitioned into common blocks 511. A common block 511 can be used to create one or more assembled complete messages 519 at receiver endpoints 505. At step 605, the common blocks 511 are routed to receiver endpoints 505 via a policy enforcement engine 517.

With the above approach, a service provider, for instance, can decrease overhead by using common blocks within the realms. Because common blocks can be stored in multiple realms, a common block would not have to be sent over a communication network over large distances when a message is sent from one realm to another. This can increase the capacity of the messaging bus as well as reduce latency.

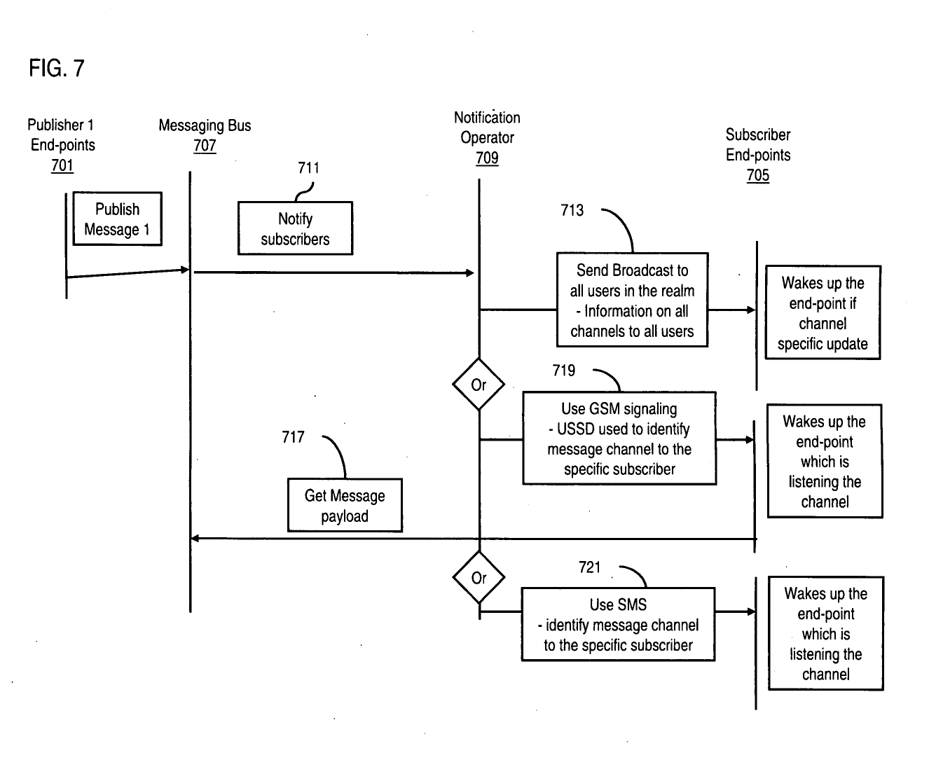

FIG. 7 is a sequence diagram for notifying subscriber endpoints of new information, according to one embodiment. A notification operator 709 can be a service that services endpoints to notify the endpoints of the existence of new information from a messaging bus. To optimize battery life time on some UEs 101, a connection between a UE 101 such as a mobile device and a server servicing the UE 101 is not always on-line. To wake up the connection, a device can poll the server for new messages or the server may send a special message such as a short message service (SMS) to the UE 101. Additionally, notification can be sent over a broadcast, such as an Open Mobile Alliance (OMA) broadcast that is visible to several users or via a GSM signaling channel such as the Unstructured Supplementary Service Data (USDD). A publisher endpoint 701 can publish a message 703 to be sent to a subscriber endpoint 705. The message bus 707 can notify subscribers 711 via a notification operator 709 to notify the subscriber of new content that the subscriber endpoint 705 can access.

In one embodiment, the notification operator can send a broadcast 713 to all of the users in a realm about new information available on all channels to all users. A subscriber endpoint 705 will wake up if there is new information available on a channel to which the subscriber endpoint 705 subscribes. This approach allows for the device of the subscriber to save power and battery life as the subscriber need not wake up for channel updates to which the subscriber does not subscribe. The subscriber endpoint 705 can then request 715 that the message payload is sent to the subscriber endpoint 705.

In another embodiment, the notification operator 709 can use a USSD transmission over an identified GSM signaling channel 719 associated to a specific subscriber 705. Alternatively, an SMS channel 721 can be utilized. A USSD transmission, for example, can utilize less carrier overhead related costs than an SMS. The subscriber endpoint 705 wakes up if the subscriber endpoint 705 is listening to the message channel. Thus, the subscriber to save power and battery life by waking up to specific transmissions. The subscriber endpoint 705 can then request 715 that the message payload is sent to the subscriber endpoint 705. The subscriber need not request the message payload, thereby conserving power and extending battery life by delaying a message payload request.

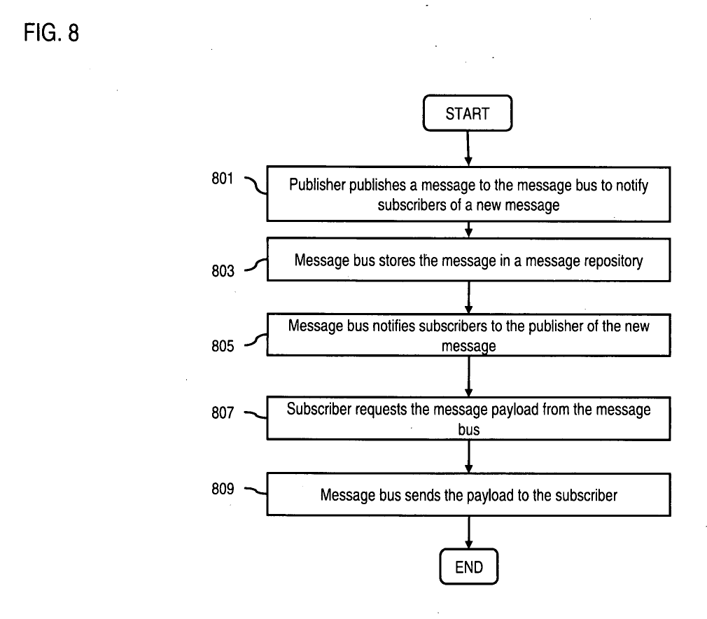

FIG. 8 is a flowchart of a process of notifying a subscriber endpoint of new information, according to one embodiment. At step 801, a publisher application publishes a message to the bus to notify subscribers of a new message. At step 803, the message bus stores the message in a message repository. At step 805, the message bus notifies the subscribers to the publisher of the new message. The message bus can notify the subscribers using a broadcast or a GSM signaling channel. At step 807, the subscriber requests the message payload from the message bus. At step 809, the message bus sends the payload to the subscriber.

With the above approach, the messaging bus is optimized to message UEs 101 to wake the UE. This can increase the battery life of a UE 101 while minimizing the service provider's costs.

The processes described herein for providing message routing optimization for these applications may be implemented via software, hardware, e.g., general processor, Digital Signal Processing (DSP) chip, an Application Specific Integrated Circuit (ASIC), Field Programmable Gate Arrays (FPGAs), etc., firmware or a combination thereof. Such exemplary hardware for performing the described functions is detailed below.

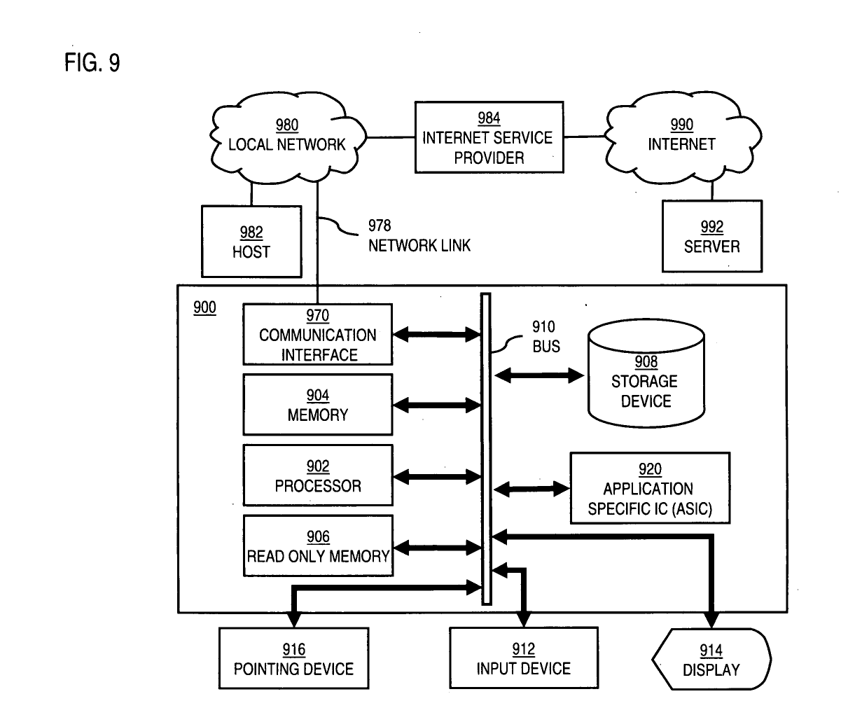

FIG. 9 illustrates a computer system 900 upon which an embodiment of the invention may be implemented. Computer system 900 is programmed to provide application messaging as described herein and includes a communication mechanism such as a bus 910 for passing information between other internal and external components of the computer system 900. Information (also called data) is represented as a physical expression of a measurable phenomenon, for example electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information related to application messaging over a communication network. The set of operations include bringing information in from the bus 910 and placing information on the bus 910. The set of operations also include, for example, comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for application messaging. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for application messaging, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for applications like sharing photos.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

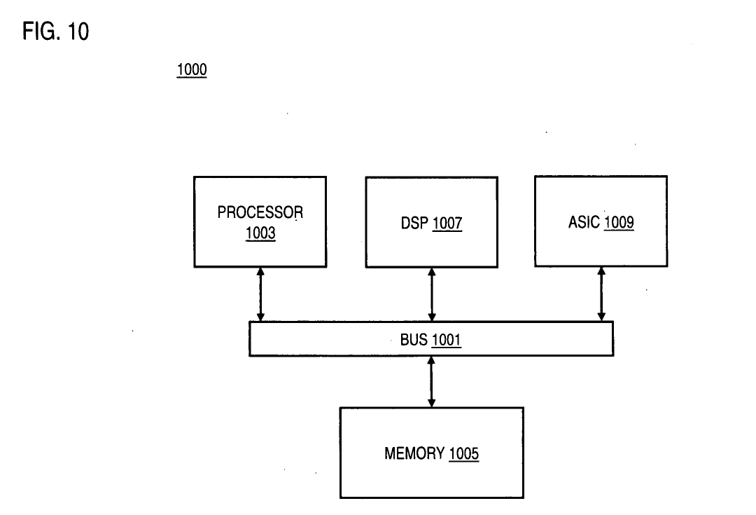

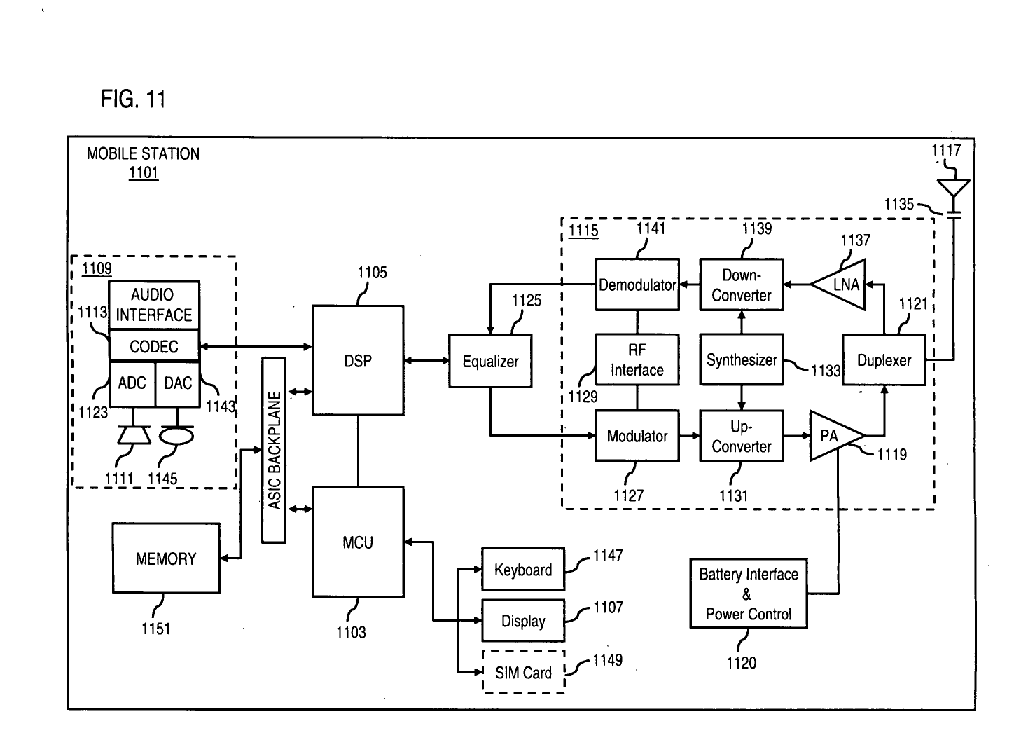

FIG. 10 illustrates a chip set 1000 upon which an embodiment of the invention may be implemented. Chip set 1000 is programmed to application data through a messaging bus as described herein and includes, for instance, the processor and memory components described with respect to FIG. 10 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide optimize the transfer of messages over multiple realms. The memory 1005 also stores the data associated with or generated by the execution of the inventive steps.

FIG. 11 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions, such as photo sharing and news applications. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 according to, for example, an multi-touch user interface. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
encoding a message from a sender application platform associated with a realm; and
determining that the message is to be transported, using a messaging bus, over one or more other realms to a receiver application platform,
wherein each of the application platforms is configured to communicate over the messaging bus and to provide one or more services to one or more mobile devices.

2. A method of claim 1, wherein the encoding of the message is coded using an adaptive algorithm configured for the first realm.

3. A method of claim 2, wherein the adaptive algorithm includes an adaptive Huffman code.

4. A method of claim 2, wherein the realm maintains a local code module and has a corresponding global code module, the method further comprising:
storing a code associated with the encoded message in the local code module; and
updating the global code module with the code.

5. A method of claim 3, wherein the encoding step further comprises partitioning the message into common blocks, the method further comprising:
routing the common blocks to the receiver application platform according to a predetermined policy.

6. A method of claim 3, further comprising:
initiating sending of a notification to the one or more mobile devices of an incoming message using a broadcast, a signaling channel, or a short message.

7. A method of claim 1, wherein the messaging bus is distributed geographically.

8. An apparatus comprising:
at least one memory including computer program code,
the at least one memory and the computer program code configured to, with the at least one processor, cause the apparatus to perform at least the following,
encode a message from a sender application platform associated with a realm, and
determine that the message is to be transported, using a messaging bus, over one or more other realms to a receiver application platform,
wherein each of the application platforms is configured to communicate over the messaging bus and to provide one or more services to one or more mobile devices.

9. An apparatus of claim 1, wherein the encoding of the message is coded using an adaptive algorithm configured for the first realm.

10. An apparatus of claim 9, wherein the adaptive algorithm includes an adaptive Huffman code.

11. An apparatus of claim 9, wherein the realm maintains a local code module and has a corresponding global code module, the apparatus being caused to further:
store a code associated with the encoded message in the local code module; and
update the global code module with the code.

12. An apparatus of claim 9, wherein the message is partitioned into common blocks, the apparatus being caused to further:
route the common blocks to the receiver application platform according to a predetermined policy.

13. An apparatus of claim 9, wherein the apparatus is further caused to:
initiate sending of a notification to the one or more mobile devices of an incoming message using a broadcast, a signaling channel, or a short message.

14. An apparatus of claim 8, wherein the messaging bus is distributed geographically.

15. A method comprising:
receiving an encoded message from a sender application platform associated with a source realm;
retrieving a code corresponding to the encoded message;
decoding the encoded message using the retrieved code; and
initiating sending of the decoded message to a receiver application platform associated with a destination realm,
wherein each of the application platforms is configured to provide one or more services to one or more mobile devices.

16. A method of claim 15, further comprising updating the local code module by a global code module.

17. A method of claim 16, wherein the updating step updates the local code module based on decoding needs or a predictive mode.

18. A method of claim 16, wherein the decoding step further comprises decoding common blocks using a policy enforcement engine.

19. A method of claim 16, wherein the encoded message is coded using an adaptive Huffman code.

20. A method of claim 16, wherein the source realm and the destination realm are geographically dispersed.
